(19) United States
(12) Patent Application Publication
(10) Pub. No.: US 2007/0043823 A1
(43) Pub. Date: Feb. 22, 2007

(54) System and method for pushing activated instant messages

(76) Inventors: David Alson George, Somers, NY (US); Raymond Byars Jennings III, Ossining, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/207,470

(22) Filed: Aug. 19, 2005

(51) Int. Cl. G06F 15/16

(52) U.S. Cl. 709/207

(57) ABSTRACT

A system and method for sending activated instant messages includes determining a condition under which an activated instant message is permissible and determining if the condition is met. If the condition is met, the activated instant message is sent such that the activated instant message causes a receiver device of the activated instant message to automatically perform an instruction sent by the sender.

### BACKGROUND

1. Technical Field

The present invention relates to content delivery over networks, and more particularly to system and methods for pushing content or providing access to content using instant messaging.

2. Description of the Related Art

Instant messaging can be a useful way of communicating between on-line users. Users can send a text message with or without attachments to one or more other users. Instant messages may be sent directly to a computer associated with the screen name of the instant message receiver.

Current instant messaging clients can parse a text message for any URL and allow the user to click on the URL within the text message in order to launch their web browser to open the URL.

It would be advantageous; however, if there was a way to cause an instruction to be performed by a receiver device using an instant message without the receiver intervening as set forth in the present invention.

### SUMMARY

A system and method for sending activated instant messages includes determining a condition under which an activated instant message is permissible and determining if the condition is met. If the condition is met, the activated instant message is sent such that the activated instant message causes a receiver device of the activated instant message to automatically perform an instruction sent by the sender.

A system for sending activated instant messages includes an administrator which coordinates one or more conditions and/or user profiles to determine whether activated instant messages may be sent and received by clients. A user profile and detection module store user data and status such that when a sender attempts to send an activated instant message, the administrator determines whether the sender of the activated instant message is permitted to send the activated instant message and whether a receiver of the activated instant message is permitted to receive the activated instant message. The activated instant message, if received, causes a receiver device of the activated instant message to automatically perform an instruction sent by the sender without intervention of a client receiving the activated instant message.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a system for sending activated instant messages in accordance with an illustrative embodiment; and

FIG. 2 is a block/flow diagram showing a system/method for sending activated instant messages in accordance with another illustrative embodiment.

### DETAILED DESCRIPTION OF PREFERRED EMBODIMENTS

Embodiments of the present invention include systems and methods for an instant messaging system (such as, e.g., Lotus Sametime™) to use the instant messages to cause a receiver to act on a request by the sender. For purposes of explanation, a general term, activated instant message, will be used throughout this disclosure to describe an instant message which automatically performs an operation or execute an instruction upon receipt. For example, in one embodiment, a message receiver receives a message in the form of an opened web page to read the message or to solicit a response. Other forms of activated IMs will be illustratively described herein.

The present invention deals with sending text messages that include a URL or other attachments that are automatically opened via the receiver's web browser or appropriate application software. One aim is to provide additional functionality to instant messaging systems which have a large user base and are increasing in popularity within companies and enterprises. By employing instant messaging, the time to send content to a user may be based on their present state, e.g., Active, Away, etc.

Functionality from applications, like IBM's ISSI™, which has a specific purpose, can be incorporated directly into actual text messages of the instant messaging system without any significant modification to the instant messaging client.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

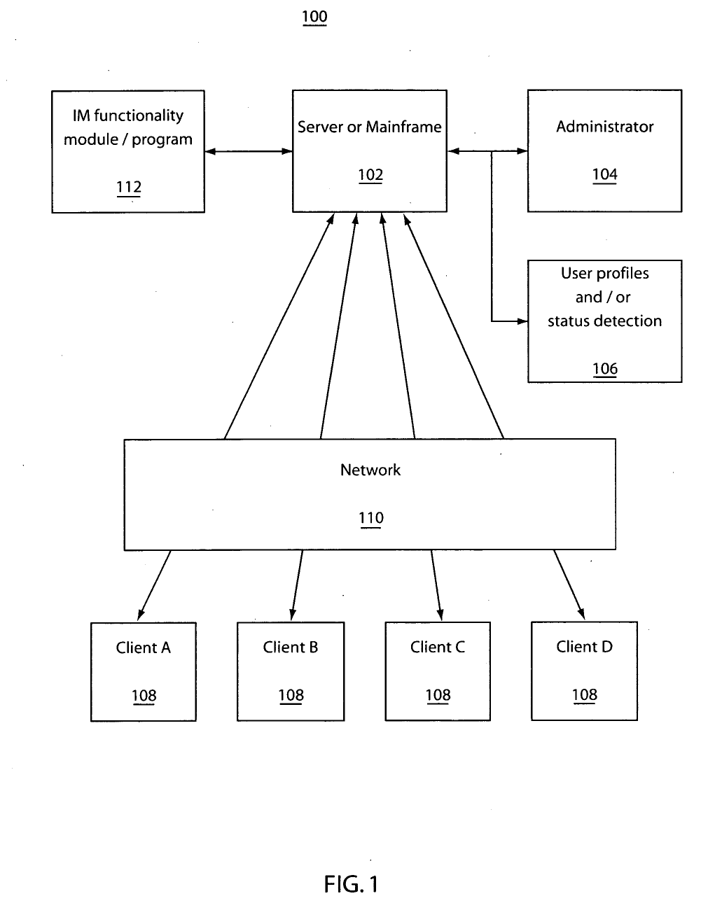

Referring now to the drawings in which like numerals represent the same or similar elements and initially to FIG. 1, an illustrative system 100 is shown which supports instant messaging applications and provides functionality in accordance with the present invention. System 100 includes one or more servers or mainframe computers 102. In one embodiment, server 102 is employed for pubic network applications, such as Internet, telephone, cable or other network relates communications and applications. In a private or corporate setting, server 102 (or mainframe) supports inter-company communications and applications. Server 102 may include an application specific push system, such as IBM's ISSI™ system, for carrying out distribution of information as will be described in greater detail below.

System 100 includes a system administrator 104 which may be implemented automatically by machine or be a manual administrator or a combination of both. Administrator 104 maintains records of programs or systems functions, provides troubleshooting services and otherwise maintains system functionality and upgrades.

An instant messaging module/program 112 interacts with server 102 to perform instant messaging tasks and to perform operations in accordance with the present invention. Instant messaging program 112 includes protocols for communication between a plurality of clients 108 over a communications link or network 110. Such protocols permit instant messaging between clients 108 over the network 110. Network 110 may include the Internet, a local area network, a wireless network, such as a cellular network, a cable or satellite network or any other system where communications between locations or within a same location is possible.

In a particularly useful embodiment, additional functionality is provided by module 112 within instant messaging software for sending text based messages that include a URL(s) that cause the user's machine to act appropriately on the message. Typical instant messaging clients allow for a sender to include a URL within a text message where the receiver can click on it to launch the appropriate application. However, this is a manual process. In accordance with one embodiment, by sending a URL within a text message of an instant messaging system, the receiver of the instant message can automatically react to the message by launching the appropriate application for the URL (e.g., web browser, UseNet reader, email, peer to peer (P2P) application, or any other IM application).

To illustrate, a user or client A 108 receives an instant message from client B 108, which includes a URL of the client A's personal website. Upon receiving the instant message, client B's web browser automatically opens revealing the website corresponding to the URL. A remote user/administrator/manager 104 can enforce policies on users when they are in predetermined states, e.g. “active”, “away”, etc.

Security measures may be taken to prevent abuse and to ensure that the users are permitted to push activating instant messages to other users. For example, say client C 108 sets system parameters to receive activating instant messages from the administrator 104 only. When the client A 108 attempts to send an activating instant message to client C 108, the administrator 104 blocks the message. A message may be sent to client A 108 alerting him to the blocked message.

User profiles and/or status detection module 106 includes information on users to store the user settings (such as instant message blocking, etc.) and to group user information. For example, if a software application is used by client A and client B, and an upgrade is available for that software application, administrator 104 would send an instant message to clients A and B, which are grouped, when their status was away to provide an upgrade of their software application. This may include actually sending an applet which runs the upgrade in their absence.

Module 106 also checks the user's status (e.g., active, away, etc.) to determine if a given action by the server 102 or another client 108 is appropriate based on this status. For example, if clients A and B are in the group that uses a particular software application, and a warning that an update is available for that software application may be set to be sent to the group only if the group members have a status of active. Administrator 104 looks up the members of the group (client A and B) stored in module 106 and determines for that group which members are active (checking status in module 106). A security policy check may also be performed. If all the conditions are met, an instant message is sent to the active clients A and B if they are active. Otherwise, the group list is maintained and the instant message is sent only when the status changes to active for each individual in the group.

In another embodiment, system 100 permits for a set of users to be acted on at a given time specified by the administrator 104 (e.g., make operating system updates occur when a user's presence is “away”, or make updates occur at night when network activity is low.). System 100 permits instant messaging systems to perform and provide for additional functionality without needing specific code changes to the instant messaging system. In the case of a website URL that is sent and that automatically opens, the burden for handling the different types of functionality is preferably placed on the remote site that the URL specifies. For example, the website may be provided with controls, indicators to confirm receipt or ensure that the users have read the web page and/or instant message content. For example, a button on the web site may read “I have read this”, the reader would “press” the button to indicate the message was read.

Server 102, administrator 104 or each client 108 may include a list of senders (buddies) that are authorized to send activated instant messages. A list of senders may be stored on each client machine and may be user defined, or a list of senders may be stored with administrator 104 (or module 106) or a combination of both may be performed. When sending URLs, the URLs can be automatically launched at the receivers device if the URL is from a pre-approved source (e.g., of the list of senders. Policies implemented by server 102 may be employed to prevent malicious use and can be based on, for example: (a) a set of specified users who are allowed to send activated instant messages, (b) only administrators (network/IT, etc.) where the user cannot block them (e.g. from administrator 104), (c) the URL type being launched (e.g., only launch “https” URLs, or a pre-designated set of URLs), (d) the domain name of the remote hosts (e.g., only launch within *.ibm.com). Other conditions or limitations may be placed on individual clients 108 or the system 100 as a whole.

Embodiments of the present invention may be employed in many instances. A few examples are disclosed herein below. These examples should not be construed as limiting. In one embodiment, the present invention is employed for a user compliance application. A URL is sent to users that requires acknowledgment of reading/understanding of the content provided in a website associated with the URL. For example, a new company policy may be distributed by a system administrator, which opens a web page and displays information relating to these company policies. The web page once opened may require that a user acknowledge reading and/or understanding the policy, e.g., discrimination, hiring, financial, benefits, etc., to close the website/browser.

In another embodiment, computer security may be maintained by employing the system in accordance with the present invention. A URL is sent to users that launches an applet to install an operating system (OS) or security fix. This embodiment is particularly useful in stopping virus/worms for spreading as information technologists (IT) wait for everyone to run appropriate virus protection software, etc.

In another embodiment, in an expert systems/customer service application, a user asks a question over an instant message session and has the appropriate web page opened automatically. For example, How do I reset my password? An instruction page is automatically opened, which is responsive to this query. Other expert system applications may include an automated user ID system, where an inquiry such as typing a persons name may automatically open up a directory entry showing that persons phone number, address, email or any other stored information.

In a user collaboration/conferencing embodiment, instead of sending URLs or pictures, URLs are provided to users that cause local applications on the client device 108 to launch automatically at a particular time. For example, when a speaker begins to communicate about a topic, an MPEG movie about that topic starts up. In one illustration, a user instant messages the terms, “internal combustion engine” to the server or another client, and an informational movie about internal combustion engines is automatically sent and played at the client's device.

In another application, Internet chat or other chatrooms may be improved by providing less interaction needed by the receiver by opening up active windows with information or websites as provided by the sender.

It should be understood that clients 108 may include messaging capabilities as provided by personal digital assistants, cell phones, computers, laptops, personal computing device or any other platform that can support instant messaging.

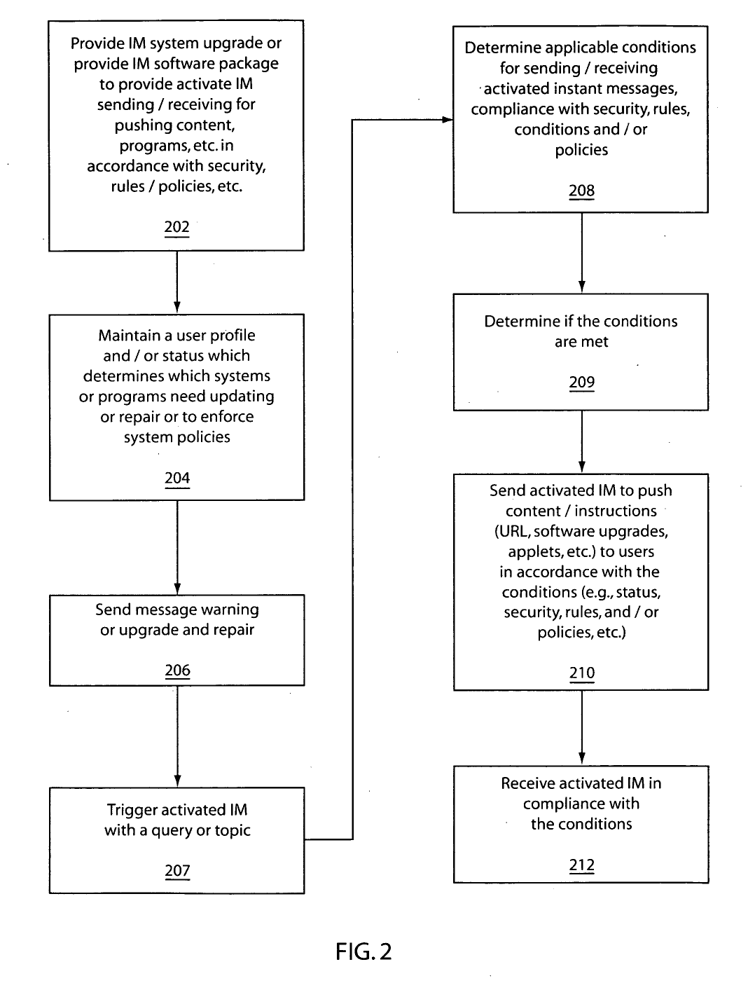

Referring to FIG. 2, a block/flow diagram shows a system/method for implementing activated instant messages in accordance with embodiments of the present invention. In block 202, an instant message system is provided, which includes the capability of sending activated instant messages. This capability may be provided by upgrading an existing IM software program or providing an IM program having the activated instant messaging capability.

The process for sending an activated instant message is preferably performed by the sender (other user, system administrator, etc.). This may include manual method or the sender's IM application providing the correct syntax for the message. As an analogy, some people when they create web pages do so manually, adding all of the HTML tags in by hand (manual method). Others use may employ a web page design application that will fill in all of the HTML formatting tags for them.

For simple tasks, e.g., sending a URL that will open a webpage, the manual method may be preferred. To send a program to be installed by the receiver would probably need the use of the IM application to set the correct syntax for the message.

In block 204, user profiles are stored and maintained with pertinent information for system administration. These profiles may include information, or subscriptions for information, applications or software packages that the client devices use or group listings if the clients are members of a group (on a buddy list or a subscriber list for a service, etc.). In addition, a current status of each member is maintained and known, as well as rules or policies that should be followed. The rules and policies are implemented in accordance with, for example, the user's current status (away, active, etc.), subscriptions (e.g., send me updates on my software), conditions (no correspondence after 8 PM, etc.), security (e.g., the sender is authorized to send the activated IM) or any other conditional relationships.

In block 206, a warning message may be sent via instant message giving advanced warning of a system change, repair or update that may follow. Alternately, a triggering event such as a query from a user may trigger an activated IM, in block 207.

In block 208, a determination is made as applicable conditions surrounding the sending and/or receiving an activated instant message are present. These conditions may include the status of the receiver (e.g., active, away), scheduling conditions (e.g., receive message until 8 PM), approved sender or receiver (e.g., on a group list or appropriate security level for sending or receiving messages), approved content (e.g., approved URLs or information), etc.

In block 209, the conditions are checked to determine if the conditions are satisfied. These conditions are maintained and coordinated by the system administrator and checked against a user profile module, which stores the particulars regarding user information needed to determine if the conditions are met.

In block 210, an activated IM is sent by a user or by a system administrator to one or more other users or administrators. It is determined whether the activated IM is in compliance with the various rules and policies of the system as illustratively set forth above. As mentioned, different degrees of security can be setup to prevent malicious intent. For example, only open web pages sent by people on the receiver's buddy list (Internet case), only open web pages sent by the administrator (e.g., where there is the equivalent of global entries within every user's buddy list), only open web pages within a certain domain name(s) or designation(s) (e.g., *.ibm.com), etc.

In block 212, the activated IM is received in compliance with the rules and policies. The received activated IM, automatically opens a webpage, plays a video, audio or data stream, runs an applet or other program to provide information or a service, initials a local application on the user's device or performs any other authorized action. Some examples include pushing a URL to a user that requires the user's compliance such as reading and acknowledging documents such as anti-discrimination policy, anti-harassment policy, security compliance, etc., pushing a URL to a user that launches a java™ applet to install a needed OS security fix, use software to ensure that virus protection is active or force an installation of software if the user has not done so or if there is a virus/worm spreading through the company and the installation is needed in an emergency.

Other applications may include user collaboration, instead of sending an image via the instant message client, send a URL which is automatically opened at the recipient's screen. Expert systems/customer service where a question may be asked via instant message and the corresponding help file opens via the web browser, etc. Other application may provide improvements to chatroom operation.

Having described preferred embodiments of a system and method for pushing activated instant messages (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for sending activated instant messages, comprising:
determining a condition under which an activated instant message is permissible;
determining if the condition is met; and
if the condition is met, sending the activated instant message such that the activated instant message causes a receiver device of the activated instant message to automatically perform an instruction sent by the sender.

2. The method as recited in claim 1, wherein determining a condition includes determining a status of the receiver device.

3. The method as recited in claim 2, wherein determining if the condition is met includes determining if the receiving device has an appropriate status so that the activated instant message can be sent.

4. The method as recited in claim 1, wherein determining a condition includes determining whether the sender is an approved sender.

5. The method as recited in claim 1, wherein determining a condition includes determining whether content of the activated instant message is approved content.

6. The method as recited in claim 1, wherein determining a condition includes determining whether the receiver is an approved receiver.

7. The method as recited in claim 1, wherein the activated instant message includes a web address and the step of sending includes opening a website on the receiver device.

8. The method as recited in claim 1, wherein the activated instant message includes program code for at least one of: providing virus/worm protection for the receiving device, upgrading a software application and downloading information or a program.

9. The method as recited in claim 1, further comprising triggering the activated instant message by sending a user query or topic.

10. A computer program product comprising a computer useable medium including a computer readable program, wherein the computer readable program when executed on a computer causes the computer to perform the method steps of:
determining a condition under which an activated instant message is permissible;
determining if the condition is met; and
if the condition is met, sending the activated instant message such that the activated instant message causes a receiver device of the activated instant message to automatically perform an instruction sent by the sender.

11. The computer program product as recited in claim 10, wherein the step of determining a condition includes determining a status of the receiver device.

12. The computer program product as recited in claim 11, wherein the step of determining if the condition is met includes determining if the receiving device has an appropriate status so that the activated instant message can be sent.

13. The computer program product as recited in claim 10, wherein the step of determining a condition includes determining whether the sender is an approved sender.

14. The computer program product as recited in claim 10, wherein the step of determining a condition includes determining whether content of the activated instant message is approved content.

15. The computer program product as recited in claim 10, wherein the step of determining a condition includes determining whether the receiver is an approved receiver.

16. The computer program product as recited in claim 10, wherein the activated instant message includes a web address and the step of sending includes opening a website on the receiver device.

17. The computer program product as recited in claim 10, wherein the activated instant message includes program code for at least one of: providing virus/worm protection for the receiving device, upgrading a software application and downloading information or a program.

18. The computer program product as recited in claim 10, further comprising the step of triggering the activated instant message by sending a user query or topic.

19. A system for sending activated instant messages, comprising:
an administrator which coordinates one or more conditions and/or user profiles to determine whether activated instant messages may be sent and received by clients; and
a user profile and detection module which stores user data and status such that when a sender attempts to send an activated instant message, the administrator determines whether the sender of the activated instant message is permitted to send the activated instant message and whether a receiver of the activated instant message is permitted to receive the activated instant message;
wherein the activated instant message, if received, causes a receiver device of the activated instant message to automatically perform an instruction sent by the sender without intervention of a client receiving the activated instant message.

20. The system as recited in claim 19, wherein the one or more conditions include at least one of: a status condition of the receiver device, an approved sender, an approved receiver, and approved content.

21. The system as recited in claim 19, wherein the activated instant message includes a web page URL, a virus/worm protection program, a software application upgrade and a program download.
